(19) United States
(12) Patent Application Publication
(10) Pub. No.: US 2026/0052590 A1
(43) Pub. Date: Feb. 19, 2026

(54) FIRST AND SECOND COMMUNICATION DEVICES AND METHODS FOR USE IN A MULTI-LINK OPERATION IN A WIRELESS COMMUNICATION SCENARIO

(71) Applicant: Sony Group Corporation, Tokyo (JP)

(72) Inventors: Daniel VERENZUELA, Stuttgart (DE); Thomas HANDTE, Stuttgart (DE); Ken TANAKA, Stuttgart (DE)

(73) Assignee: Sony Group Corporation, Tokyo (JP)

(21) Appl. No.: 19/100,947

(22) PCT Filed: Aug. 2, 2023
(86) PCT No.: PCT/EP2023/071378

§ 371 Date: Feb. 4, 2025

(30) Foreign Application Priority Data
Aug. 12, 2022 (EP) 22190279.4

(51) Int. Cl. H04W 76/14

(52) U.S. Cl. CPC H04W 76/14

(57) ABSTRACT

First communication device configured to simultaneously exchange data units via at least two links with one or more other communication devices including a second communication device that is configured to simultaneously exchange data units via at least two links with at least one or more third communication devices, the first communication device comprising circuitry configured to reserve, if second data units are expected to be queued at the second communication device at an expected arrival time, two links for data exchange once first data units are queued at the first communication device or once third data units are queued at the second or third communication device.

### BACKGROUND

### Field of the Disclosure

The present disclosure relates to first and second communication devices and methods, in particular for use in a multi-link operation in a wireless communication scenario.

### Description of Related Art

Multi-link operation (MLO) is a feature introduced in WLAN that allows a station (STA) to establish multiple links with other STAs. MLO is a feature in the ongoing standard amendment IEEE802.11be that allows a multi-link device (MLD) to establish multiple links with one or more other communication devices depending on their capabilities. By using this feature, the MLD can have two simultaneous links with different communication devices to support various applications, including applications where there is an interdependency of the traffic on the two links.

The “background” description provided herein is for the purpose of generally presenting the context of the disclosure. Work of the presently named inventor(s), to the extent it is described in this background section, as well as aspects of the description which may not otherwise qualify as prior art at the time of filing, are neither expressly nor impliedly admitted as prior art against the present disclosure.

### SUMMARY

It is an object to provide communication devices and methods that enable low latency traffic that needs to be exchanged between multiple communication devices. It is a further object to provide a corresponding method as well as a corresponding computer program and a non-transitory computer-readable recording medium that stores therein a computer program product for implementing said method.

According to an aspect there is provided a first communication device configured to simultaneously exchange data units via at least two links with one or more other communication devices including a second communication device that is configured to simultaneously exchange data units via at least two links with at least one or more third communication devices, the first communication device comprising circuitry configured to reserve, if second data units are expected to be queued at the second communication device at an expected arrival time, two links for data exchange once first data units are queued at the first communication device or once third data units are queued at the second or third communication device.

According to a further aspect there is provided a second communication device configured to simultaneously exchange data units with a first communication device via at least a first link and with a third communication device via at least a second link, the second communication device comprising circuitry configured to:
receive a handover of the second link, reserved by the first communication device, from the first communication device at or after an expected arrival time at which second data units are expected to be queued at the second communication device, allowing the second communication device to transmit the second data units via the second link; and
transmit the second data units via the second link.

According to a further aspect there is provided another first communication device configured to simultaneously exchange data units via at least two links with one or more other communication devices including a second communication device that is configured to simultaneously exchange data units via at least two links with one or more other communication devices, the first communication device comprising circuitry configured to:
receive a handover of the first link, reserved by the second communication device, from the second communication device at or after an expected arrival time at which first data units are expected to be queued at the first communication device, allowing the first communication device to transmit the first data units via the first link; and
transmit the first data units via the first link.

According to a further aspect there is provided a second communication device configured to simultaneously exchange data units with a first communication device via at least a first link and with a third communication device via at least a second link, the second communication device comprising circuitry configured to:
reserve, if first data units are expected to be queued at the first communication device at an expected arrival time, once second or third data units are queued at the second communication device, two links for data exchange;
use at least a second link of the two reserved links for transmitting the second data units and/or receiving data units from the third communication device; and
hand over the first link of the two reserved links at or after an expected arrival time at which first data units are expected to be queued at the first communication device allowing the first communication device to transmit the first data units via the first link.

According to still further aspects corresponding methods, a computer program comprising program means for causing a computer to carry out the steps of the methods disclosed herein, when said computer program is carried out on a computer, as well as a transitory computer-readable recording medium that stores therein a computer program product, which, when executed by a processor, causes the methods disclosed herein to be performed are provided.

Embodiments are defined in the dependent claims. It shall be understood that the disclosed methods, the disclosed computer program and the disclosed computer-readable recording medium have similar and/or identical further embodiments as the claimed devices and as defined in the dependent claims and/or disclosed herein.

One of the aspects of embodiments of the disclosure is to make use of a joint peer-to-peer (P2P) MLO session where P2P communication and MLO are utilized jointly to support low latency traffic that needs to be exchanged between multiple communication devices including a first communication device (e.g. an access point, AP) and a second communication device (e.g. a non-AP station, STA). The proposed joint P2P MLO session includes mechanisms for coordinated channel access that can reduce the latency and increase the reliability of communications. These advantages are crucial in applications where the quality of service (QoS) of the traffic exchanged between multiple communication devices within the session is correlated and/or dependent of each other.

The foregoing paragraphs have been provided by way of general introduction and are not intended to limit the scope of the following claims. The described embodiments, together with further advantages, will be best understood by reference to the following detailed description taken in conjunction with the accompanying drawings.

### BRIEF DESCRIPTION OF THE DRAWING

A more complete appreciation of the disclosure and many of the attendant advantages thereof will be readily obtained as the same becomes better understood by reference to the following detailed description when considered in connection with the accompanying drawings, wherein:

FIG. 1 shows an example of a communication setup for XR applications within the context of WLAN.

FIG. 2 shows a diagram of a communication setup illustrating how an XR application can be supported with the current features in the IEEE 802.11 standard.

FIG. 3A shows a diagram of queued traffic.

FIG. 3B shows a diagram of a communication setup according to an embodiment of the present disclosure.

FIG. 4 shows an embodiment of a communication scheme according to the present disclosure in case the traffic at the first communication device is queued first.

FIG. 5 shows another embodiment of a communication scheme according to the present disclosure in case no traffic is queued at the second communication device and the first communication device resumes using a transmit opportunity.

FIG. 6 shows another embodiment of a communication scheme according to the present disclosure in case no traffic is queued at the second communication device and the first communication device ends using a transmit opportunity.

FIG. 7 shows another embodiment of a communication scheme according to the present disclosure in case traffic at the second communication device is delayed.

FIG. 8 shows another embodiment of a communication scheme according to the present disclosure where data units are initially queued at the second communication device for transmission to the first communication device. 6

FIG. 9 shows another embodiment of a communication scheme according to the present disclosure where data units are initially queued at the second communication device for transmission to the third communication device.

FIG. 10 shows another embodiment of a communication scheme according to the present disclosure where data units are initially queued at the third communication device for transmission to second communication device.

FIG. 11 show an embodiment of a communication scheme according to the present disclosure where P2P traffic from the second communication device to the third communication device is queued first and where the first communication device starts channel access.

FIG. 12 show an embodiment of a communication scheme according to the present disclosure where P2P traffic from the second communication device to the third communication device is queued first and where the second communication device starts channel access.

FIG. 13 show an embodiment of a communication scheme according to the present disclosure where P2P traffic from the second communication device to the third communication device is queued first and where traffic at the second communication device for transmission to the first communication device is queued first.

FIG. 14 show an embodiment of a communication scheme according to the present disclosure where P2P traffic from the second communication device to the third communication device is queued first and where traffic at the second communication device for transmission to the first and third communication devices is queued first.

FIG. 15 shows an embodiment of a communication scheme according to the present disclosure using reverse direction grant for TXOP handover.

FIG. 16 shows an embodiment of a communication scheme according to the present disclosure using contention free Poll for TXOP handover.

FIG. 17 shows another embodiment of a communication scheme according to the present disclosure in which the traffic at the first communication device is queued first.

FIG. 18 shows another embodiment of a communication scheme according to the present disclosure in which the traffic at the second communication device is queued first.

### DETAILED DESCRIPTION OF THE EMBODIMENTS

Developments in the field of extended reality (XR), which includes virtual reality (VR) and augmented reality (AR), are enabling the rise of interactive applications between remote and local users. Exemplary applications are: i) XR gaming where remote players interact with local players within the same virtual environment, ii) Remote certification, consultation or training programs for industrial processes where remote experts can interact with local personnel at industrial facilities by sharing a virtual environment.

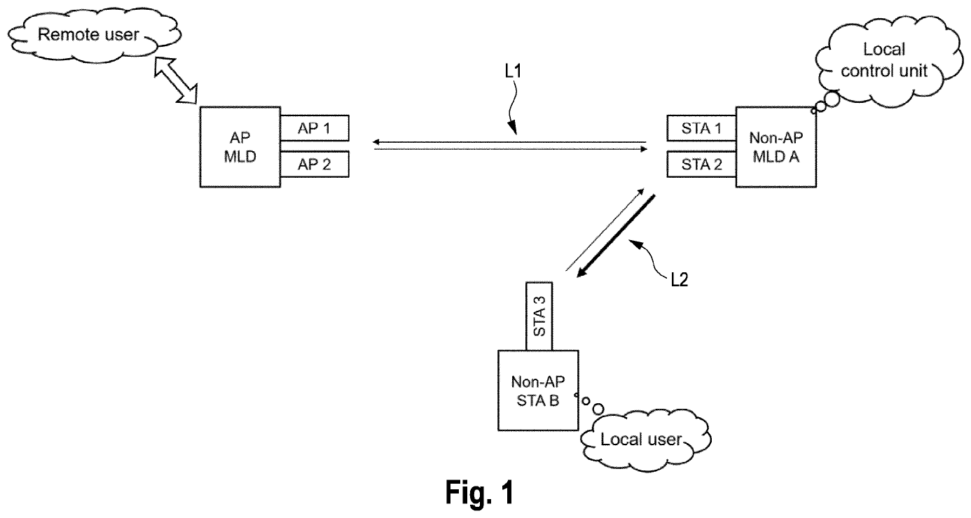

In XR applications a virtual environment is created locally for the remote and local users to experience and interact with. The virtual environment can be fully digital (e.g., XR gaming) or mixed with the local environment in AR fashion (e.g., industrial applications). FIG. 1 shows an example of a communication setup for XR applications within the context of WLAN. The access point (AP) multi-link device (MLD), herein also called first communication device, offers internet or wide area network (WAN) connectivity (e.g. home network router) to communicate with remote users. The non-AP MLD A, herein also called second communication device, represents a local control unit (e.g. gaming console like Playstation) that will create the virtual environment for the local users to access in order to interact with remote users. It also controls the flow of information between local and remote users. The non-AP station (STA) B, which may also be an MLD, herein also called third communication device, corresponds to the device used by a local user to interact with the virtual environment (e.g. VR glasses, smartphone, tablet, etc.). A similar communication setup can be present at the remote user locality.

As shown in FIG. 1, the data traffic for the XR application goes from/to multiple devices needing to establish multiple links. The traffic in each link is interdependent of the traffic of other links. The link between the AP MLD can be used for remote-local data exchange (e.g. of video data, audio data, haptics data, control data, game state data, etc.) For example, a link between AP1 to STA1 can exchange data corresponding to movements from a remote user in the virtual environment. The link between STA2 to STA3 can exchange rendered data, e.g. data regarding the visualization of the remote user in the virtual environment and movements of the local user reacting to it, e.g. pose data.

Apart from this interdependency between the traffic in multiple links, the nature of XR applications requires low latency and high reliability to operate appropriately. In WLAN operation, each of these links would be established independently which can result on long delays on either of the links and disrupt the performance of the entire XR application.

MLO is a feature in the ongoing standard amendment IEEE 802.11be that allows an MLD STA to establish multiple links with other STAs depending on their capabilities. By using this feature the non-AP MLD A can have two simultaneous links to support XR applications as shown in FIG. 1. The first link L1 is with the AP MLD and the second link L2 is with the non-AP STA B. For the latter, a peer-to-peer (P2P) link should be established for direct communication, otherwise the non-AP MLD A would need to route traffic via the AP to the STA 3 and vice versa, which would result in more latency.

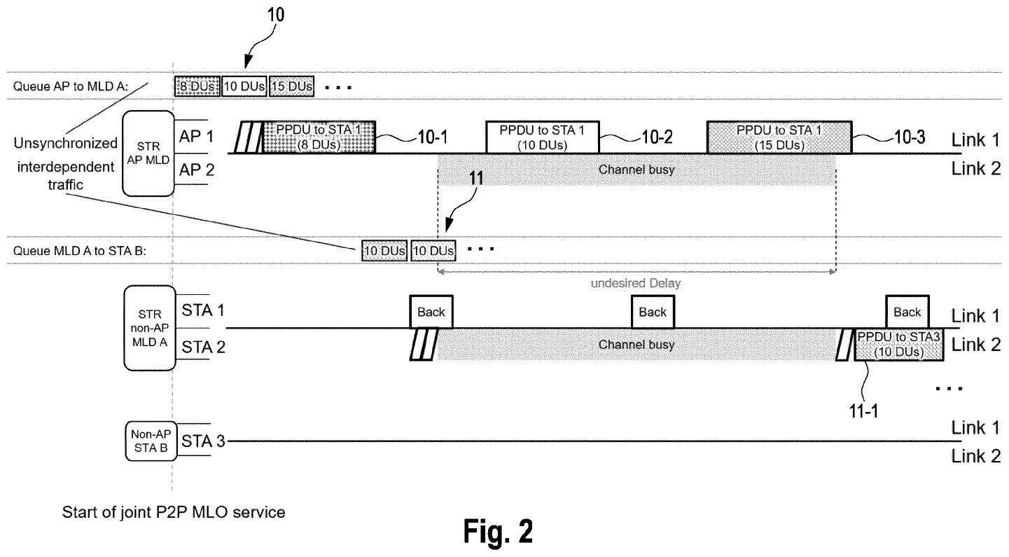

An aspect of the XR communication setup in FIG. 1 is that even though the traffic over the different links is interdependent, it is not synchronized. Thus, in separate devices, data units (DUs) may be queued for transmission at different times. FIG. 2 shows a diagram of a communication setup illustrating how an XR application can be supported with the current features in the IEEE 802.11 standard. In this case it is assumed that both the AP MLD and non-AP MLD are able to perform simultaneous transmit and receive (STR), i.e., link 1 and link 2 operate independent of each other. First, the AP MLD contends for accessing the channel to transmit data (DUs 10) to the non-AP MLD A in link 1, which are transmitted as separate sets 10-1, 10-2, 10-3. The DUs received from AP1 cause DUs 11 to be created at the STR non-AP MLD A, intended for non-AP STA B. Therefore, soon after the start of this frame exchange, the non-AP MLD A contends for channel access to transmit data (the DUs 11) to non-AP STA B in link 2. However, it is assumed that the channel is busy (e.g., occupied by another STA) and the non-AP MLD A needs to wait until the channel is idle again to resume contention and transmit the data DUs 11 (only the transmission of the first set 11-1 is shown in FIG. 2). This results in an undesired delay as shown in FIG. 2 that degrades the overall performance of the XR application even when the link 1 is fully operational.

The present disclosure presents mechanisms to coordinate channel access among devices and links such that the flow of traffic has low latency across all frame exchange from and to multiple devices belonging to the same XR application session. The interdependent traffic includes traffic that needs to be exchanged between AP and MLD A (AP link) and traffic that needs to be exchanged between MLD A and STA B (P2P link). To refer to each of these traffics separately the convention AP traffic and P2P traffic, respectively, is used herein. One of the ideas of the present disclosure is that, as soon as XR traffic is queued at any device, two transmit opportunities (TXOPs) will be obtained to accommodate the traffic needs of the other devices in the joint P2P MLO session.

For a joint P2P MLO session, initially a frame exchange may be performed in which the non-AP MLD A exchanges capabilities, requirements, and characteristics of the traffic to be transmitted in the joint P2P MLO session. Key components in this exchange may include one or more of:
indication of joint P2P MLO session which indicates that two links need to be establish simultaneously in this session; it may include which devices are involved and may indicate an identifier or differentiator of the traffic that belongs to this joint P2P MLO session apart from other traffic;
expected traffic time arrival for each link (between AP and MLD A, and between MLD A and STA B);
QoS characteristics of the traffic e.g., desired data rate, size of data units, maximum delay tolerance;
delay of DU generation after reception of a related DU;
channel access mechanism to be used for the joint P2P MLO session (as will be explained below in more detail) so that devices know, for example, if they need to wait to be triggered, or to access directly with some particular resource reservation (e.g., two links) once they have queued traffic; this may include information about who will start contending for channel access and when (there may be two cases: traffic between AP and non-AP MLD A arrives first, and traffic between non-AP MLD A and STA B arrives first); further, characteristics of the links, i.e., STR or NSTR, may be included.

The joint P2P MLO session setup can be implemented as a variant of QoS characteristics setup.

The traffic that shall be exchanged by all devices within a joint P2P MLO session belongs to the same application (e.g., an XR gaming session). The properties of this application determine how often packets/data units will need to be exchanged between devices and specific characteristics of the traffic. For example, in a highly dynamic XR gaming session, there may be frequent information exchanged about the movements of the users with very tight time deadlines. In contrast, in a less dynamic XR training session at a factory, the focus may be on transmitting very precise and reliable data to ensure an accurate representation of the environment.

The application layer at each device knows the characteristics of the traffic based on the application, which is conveyed to its MAC (media access control) and PHY (physical) layers in specific parameters. In WLAN the QoS characteristics is an element that can be used by STAs to exchange information about these specific parameters that characterize the traffic, which include one or more of: minimum and average data rates, minimum and maximum service interval, service start time, burst size and medium time.

The expected traffic arrival time can be indicated within the QoS characteristics as, for example, the service start time. In addition, the minimum and maximum service interval can be used to convey information about the time interval between expected arrival times. The exchange of traffic characteristics (e.g., QoS characteristics) may be performed as part of the joint P2P MLO session set up for at least the AP and MLD A (as shown in FIG. 1) to know the expected arrival time of each other's traffic. In addition, the STAs can update the estimated traffic arrival time at later points in time within the joint P2P MLO session.

It shall be noted in this context that the “expected arrival time” is not the same as the actual arrival time of data units, particularly due to unpredictability of the traffic and network. In communications the arrival of data units is often defined by an average arrival time and jitter. The jitter describes the variations around the arrival time, meaning how much time earlier or later the data units may arrive around the average. Thus, the disclosed embodiments referring to the expected arrival time may include cases where the data units are queued before the average arrival time and the expected arrival time may be calculated based on the average delay of the traffic in the network minus a margin based on jitter.

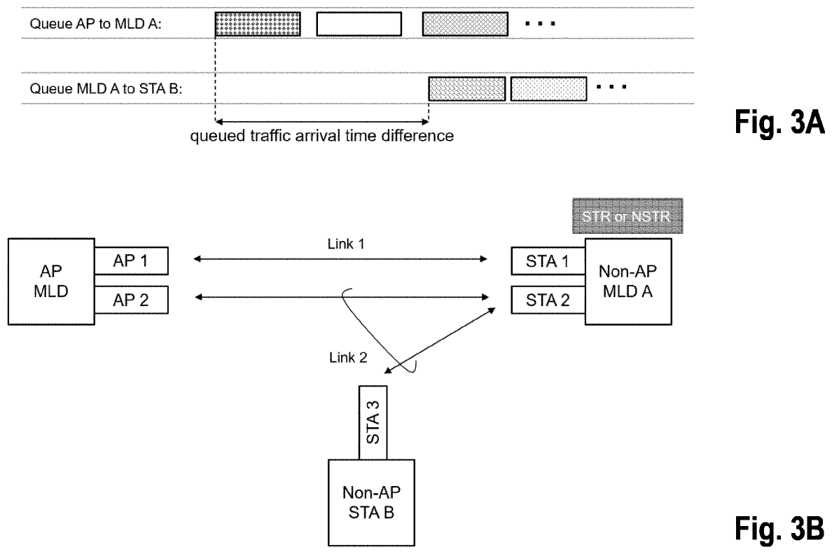

The proposed joint P2P MLO channel access mechanisms may be divided into cases according to the following conditions, as illustrated in FIG. 3 showing a diagram of queued traffic (FIG. 3A) and a diagram of a communication setup according to an embodiment of the present disclosure:
depending on which device the traffic is queued first: from AP to MLD A (AP link, link 1 in FIG. 3B), or from MLD A to STA B (P2P link, link 2 in FIG. 3B);
depending on the time difference between queued AP traffic in a first link and expected arrival time of the P2P traffic to be exchanged in a second link, called “queued traffic arrival time difference” in FIG. 3A;
depending on STR and NSTR capabilities of MLD A.

The joint P2P MLO channel access is generally performed after the joint P2P MLO session setup. Thus, the AP, MLD A and STA B are aware of the information exchanged in the joint P2P MLO session setup, including the expected time arrival of DUs at different devices.

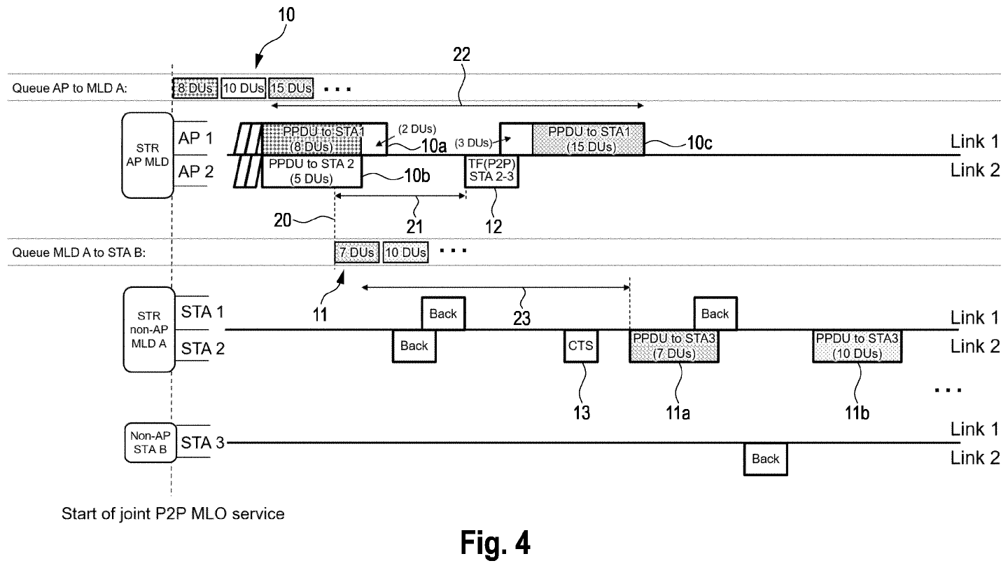

In the following, embodiments of the present disclosure will be explained with reference to FIGS. 4 to 16 where the non-AP MLD A is STR, i.e., it is able to simultaneously transmit and receive data/frames in different links.

FIG. 4 shows an embodiment of a communication scheme according to the present disclosure in which the AP traffic 10 (including the first DUs), from AP to non-AP MLD A, is queued first. The general operation is that the AP obtains a TXOP in link 1 and another TXOP in link 2 that can be used for AP traffic 10 and P2P traffic 11 (including the second DUs) belonging to the same joint P2P MLO session. First, an embodiment is described with reference to FIG. 4 under the assumption that the queued traffic arrival time difference (as indicated in FIG. 3A) is below a certain (e.g. user-defined or adaptable or predetermined/fixed) threshold. This means that there is enough queued traffic 10 at the AP to fill both links until the expected arrival of P2P traffic 11.

Initially, the AP obtains TXOPs in two links with enough resources to support both traffics (infrastructure and P2P) indicated in the joint P2P MLO session setup. The AP occupies both links with AP traffic 10 (plus another traffic if needed) until the expected arrival time 20 of P2P traffic 11 minus a certain margin, in particular the time between the end of PPDU 10b and the start of the TF 12 (basically the time needed to receive an acknowledgement and trigger the P2P traffic within the time margin 21). The PPDUs may be configured with aggregated traffic to finish at a specified time to allow P2P traffic 11 to be triggered within a certain time margin 21 after the expected arrival time 20 of P2P traffic 11. In addition, the P2P traffic 11 should not be triggered before its expected arrival time 20. Aggregation, fragmentation and/or padding operations may be included to respect the time to trigger P2P traffic. This is illustrated in FIG. 4, where the second group of 10 DUs of the AP traffic 10 is transmitted in three different PPDUs 10a, 10b, 10c. The first 5 DUs are included in PPDU 10b, which is used to occupy the channel in link 2 until it is time to trigger the P2P traffic 11. The rest of the 10 DUs are sent over link 1 as part of the PPDUs 10a and 10c. This reduces the total transmission time 22 compared to the transmission time conventionally needed for transmitting the AP traffic over illustrated in FIG. 2. Thus, in this embodiment the AP reserves the two links for data exchange once first data units are queued at the AP, which is done by transmitting first data units to the MLD A once the first data units are queued the AP.

The DUs that are used to occupy link 2 can have different priority than that of the DUs initially transmitted in link 1. It may also be possible to repeat the transmission of some DUs to occupy link 2. This would not be very efficient in terms of channel utilization, but it can be used to increase the reliability of the selected DUs. At the expected arrival of P2P traffic 11, the AP sends a trigger or trigger frame (TF) 12 allocating resources (via TXOP sharing) for the traffic between MLD A and STA B, as shown in FIG. 4. Thus, after a small signaling delay 23, during which the MLD A may transmit a signaling 13 (e.g. a clear to send CTS 13) that it intends to start a transmission, the MLD A starts transmitting PPDUs 11a, 11b containing the P2P traffic 11 via link 2 to the STA B.

Next, an embodiment is described under the assumption that the queued traffic arrival time difference is above a certain threshold (which may be the same threshold as mentioned above in the context of FIG. 4). This means that the AP does not have enough queued traffic to fill both links until the expected arrival 20 of P2P traffic 11. In this case the AP obtains a TXOP over link 1 for the AP traffic. If the AP accumulates enough traffic to fill both links before the expected arrival 20 of P2P traffic 11 minus a certain margin, then it can obtain a second TXOP in link 2 and use it as an AP link until it is time to hand it over for the P2P traffic exchange. Otherwise, i.e., if there is not enough traffic to fill both links beforehand, at the time of the expected arrival of P2P traffic minus a certain margin, the AP would contend for channel access in link 2 to allocate P2P resources for MLD A and STA B via TXOP sharing.

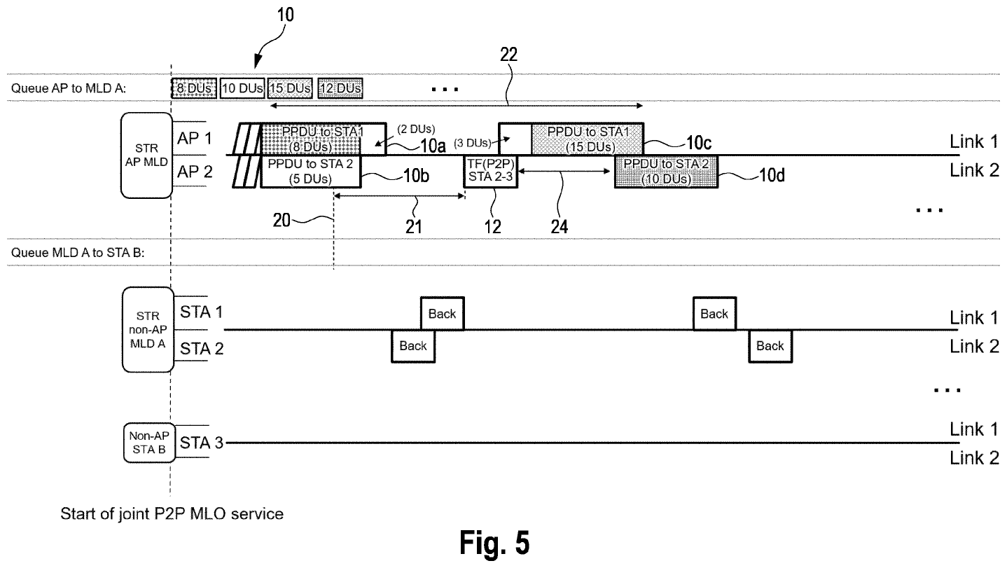

FIG. 5 shows an embodiment of a communication scheme according to the present disclosure that is similar to the communication scheme shown in FIG. 4, but where there is no response from the MLD A to the trigger or trigger frame 12 because there is no P2P traffic queued at the MLD A. Thus, if there is no response from the MLD A during a (e.g. predetermined or set) timeout period 24, the AP may resume using the link 2 to further transmit data (e.g. another PPDU 10d) to MLD A.

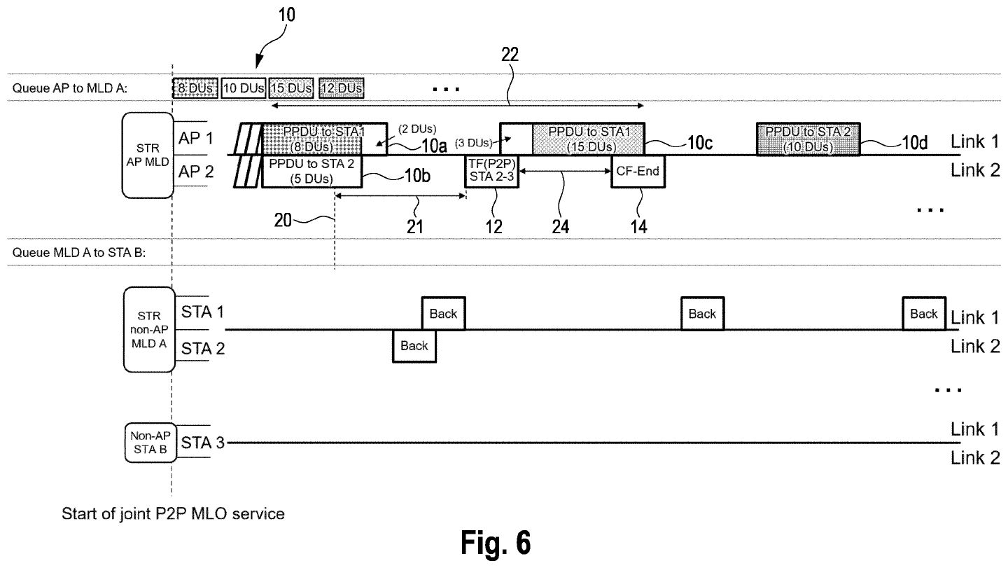

Alternatively, if the AP does not have enough traffic to continue occupying both links, it would terminate the TXOP in link 2 after the timeout period 24, e.g. by transmitting a CF-End frame 14 as illustrated in FIG. 6 showing another embodiment of a communication scheme according to the present disclosure that is similar to the communication scheme shown in FIG. 4. If there is still traffic at the AP, it may be transmitted over link 1 (e.g. as shown for PPDU 10d).

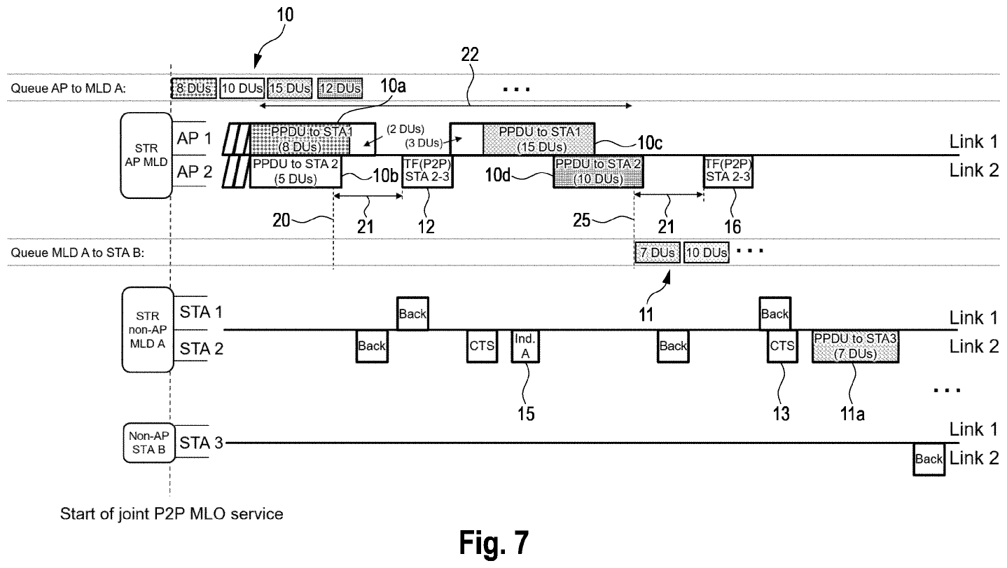

FIG. 7 shows another embodiment of a communication scheme according to the present disclosure that is similar to the communication scheme shown in FIG. 4, but where the P2P traffic (the second DUs 11) is queued later than its expected arrival 20, i.e. is delayed. In this case the MLD A does not have queued P2P traffic at the time the first trigger TF (P2P) 12 is sent from AP 2. However, the MLD A knows that soon thereafter the P2P traffic 11 will be queued. To avoid losing the already reserved resources, the MLD A can send an indication 15 (e.g. shown as “ind. A” in FIG. 7) to indicate to the AP the updated expected arrival time 25 of P2P traffic 11. Then, the AP can continue to utilize the channel in link 2 until it is time to trigger P2P traffic by another trigger or trigger frame 16, in response to which the MLD A starts transmitting over link 2 (by transmitting PPDU 11a, optionally preceded by transmission of a CTS 13).

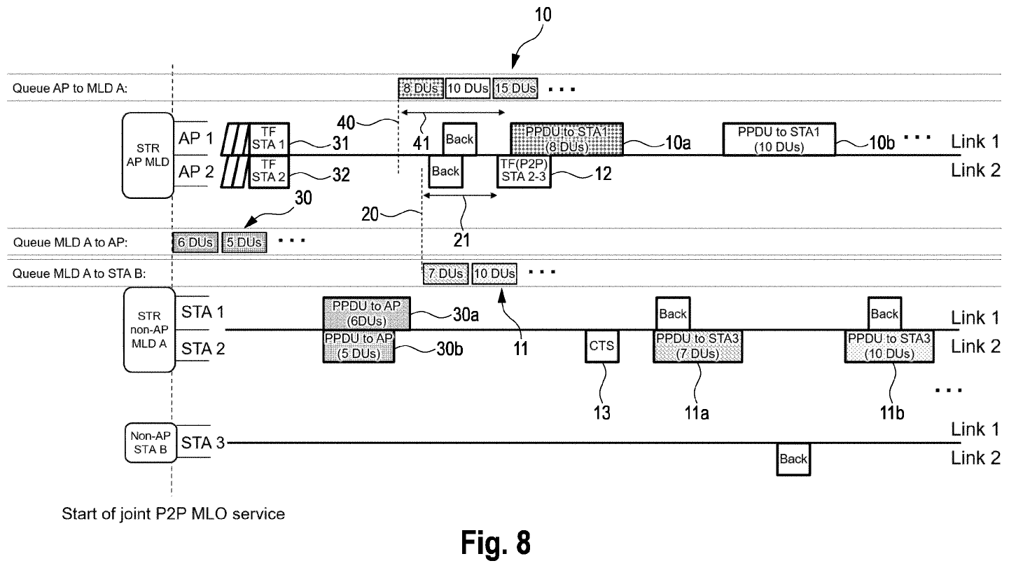

FIG. 8 shows another embodiment of a communication scheme according to the present disclosure that is similar to the communication scheme shown in FIG. 4, but where third DUs 30 are initially queued at the MLD A for transmission to the AP. The AP then transmits triggers or trigger frames 31, 32 to the MLD A, which will then transmit PPDUs 30a, 30b containing the third DUs 30 over both links 1 and 2 to the AP. Afterwards, after a time margin 41 after the expected arrival time 40 of the first DUs 10, the AP starts transmitting the first DUs 10 to the MPD A over link 1. Further, after the time margin 21 the MLD A is triggered to start transmission of the second DUs 11 to the STA B, as explained above with respect to FIG. 4. Thus, in this embodiment the AP reserves the two links for data exchange once third data units are queued at the MLD A (in this case for transmission to the AP), which is done by triggering the MLD A once the third data units are queued at the MLD A.

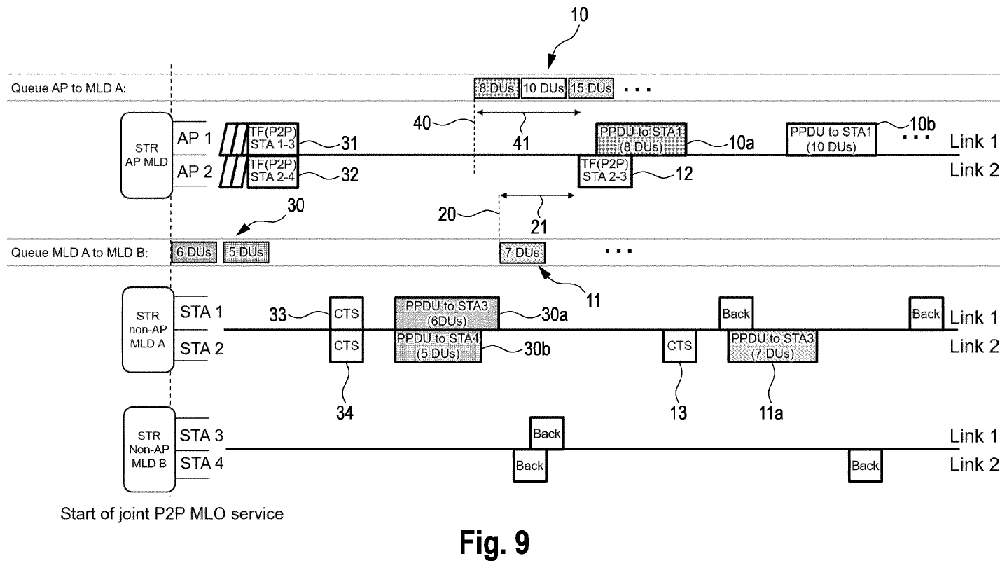

FIG. 9 shows another embodiment of a communication scheme according to the present disclosure that is similar to the communication scheme shown in FIG. 8, but where third DUs 30 are initially queued at the MLD A for transmission to MLD B, which in this embodiment is a STR device. After being triggered by the AP, the MLD A, optionally after transmitting CTS frames 33, 34, transmits PPDUs 30a, 30b containing the third DUs over links 1 and 2 to the MLD B. Afterwards, the operation substantially continues as illustrated in FIG. 8. Thus, in this embodiment the AP reserves the two links for data exchange once third data units are queued at the MLD A (in this case for transmission to the MLD B), which is done by triggering the MLD A once the third data units are queued the MLD A.

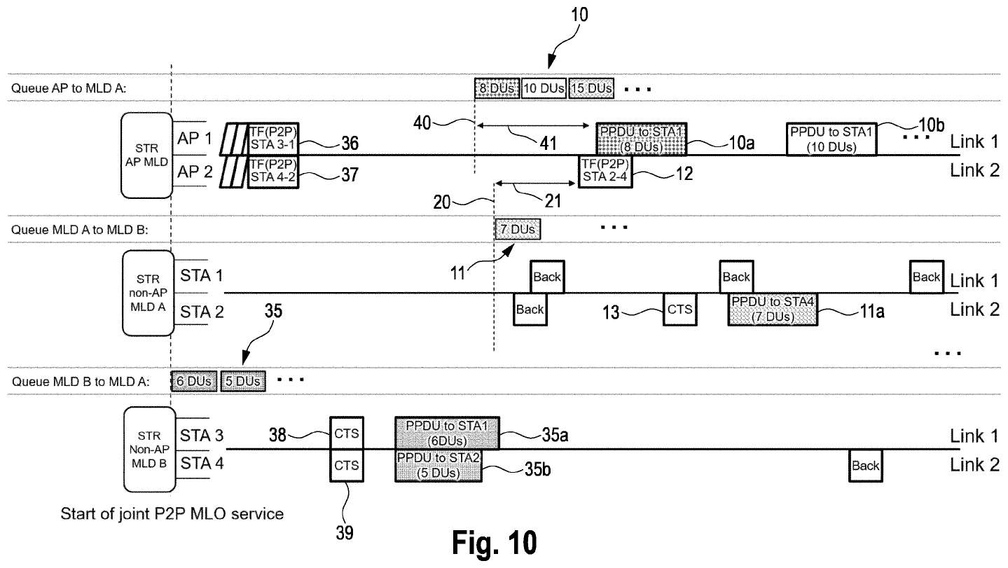

FIG. 10 shows another embodiment of a communication scheme according to the present disclosure that is similar to the communication scheme shown in FIG. 9, but where third DUs 35 are initially queued at the MLD B for transmission to MLD A. After being triggered by the AP by triggers or trigger frames 36, 37, the MLD B, optionally after transmitting CTS frames 38, 39, transmits PPDUs 35a, 35b containing the third DUs over links 1 and 2to the MLD A. Afterwards, the operation substantially continues as illustrated in FIG. 8.

Thus, in this embodiment the AP reserves the two links for data exchange once third data units are queued at the MLD B (in this case for transmission to the MLD A), which is done by triggering the MLD B to transmit third data units to the AP and/or the MLD A once third data units are queued at the MLD B.

As explained above, the third data units may be generated at the MLD A or the MLD B and they may not necessarily be part of the joint P2P MLO session. Their main use is to occupy the two links the first and/or second data units belonging to the joint P2P MLO session are queued for transmission.

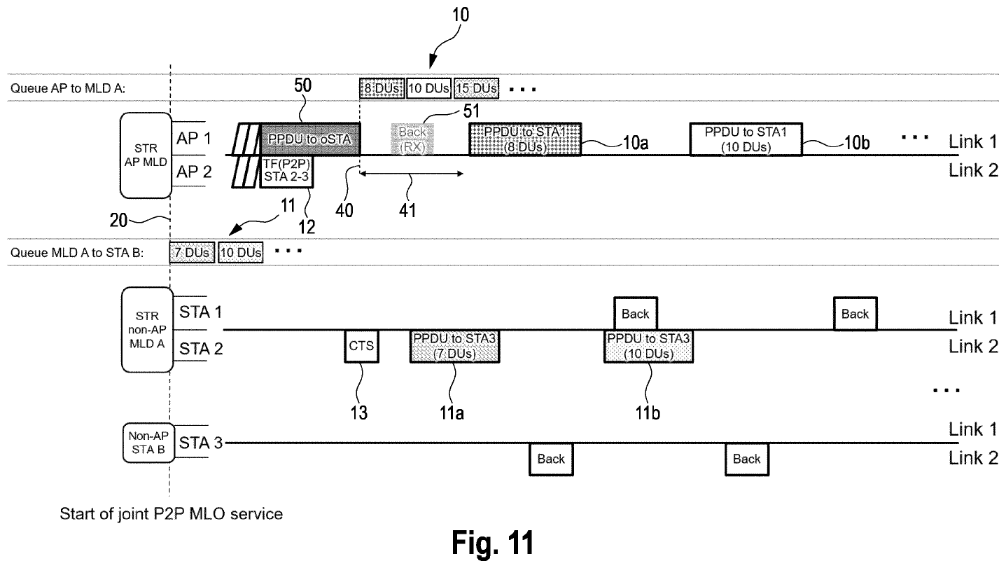

FIGS. 11 to 16 show embodiments of a communication scheme according to the present disclosure in which the P2P traffic 11 (including the second DUs), from non-AP MLD A to STA B, is queued first. This case can be further separated into two sub-cases depending on which device, AP or MLD A, starts the channel access procedure.

FIG. 11 shows an embodiment of a communication scheme according to the present disclosure where the AP starts channel access. The AP can obtain two TXOPs, one in link 1 and another one in link 2, at the time of the expected arrival 20 of P2P traffic 11 (within a certain time margin to account for processing and channel access delays) and trigger P2P traffic in link 2 via TXOP sharing. The link 1 should be occupied with infrastructure traffic (shown as PPDU 50) to other STA OSTA (not shown in FIG. 11). An acknowledgement Back (RX) 51 is received from the oSTA by the AP 1 in link 1. In this case the TXOP in link 1 may be broadcasted such that more than one STA (e.g., oSTA and STA 1) can listen to the PPDUs being sent by AP 1. Since the first PPDU 50 is not addressed to STA 1, the STA 1 may-according to standard behavior-stop decoding DUs from AP 1 in link 1 which would cause STA 1 to miss the following traffic. To avoid this, the STA 1participation in a joint P2P MLO session may stay awake during a broadcast TXOP even when the first PPDUs are not addressed to itself.

The traffic in link 1 to oSTA should finish when the DUs 10 for AP traffic to MLD A are queued, within a certain margin 41 to satisfy delay constraints. Similar to the operation described above, if there is no other AP traffic, then only link 2 can be occupied first. Afterwards, if there is enough traffic (and time), a TXOP can be obtained in link 1 to transmit other AP traffic before the arrival of AP traffic to MLD A.

In case STA B is an MLD, the AP could assign both links to the P2P traffic 11 via TXOP sharing before the arrival of AP traffic 10. The P2P assignment (in the P2P trigger or trigger frame TF 12) can be given to MLD A to control both links, or one link can be given to STA B and another to MLD A to allow for bidirectional traffic. The station that gets access to link 1 may occupy it with traffic until the expected arrival of AP traffic, within a certain margin.

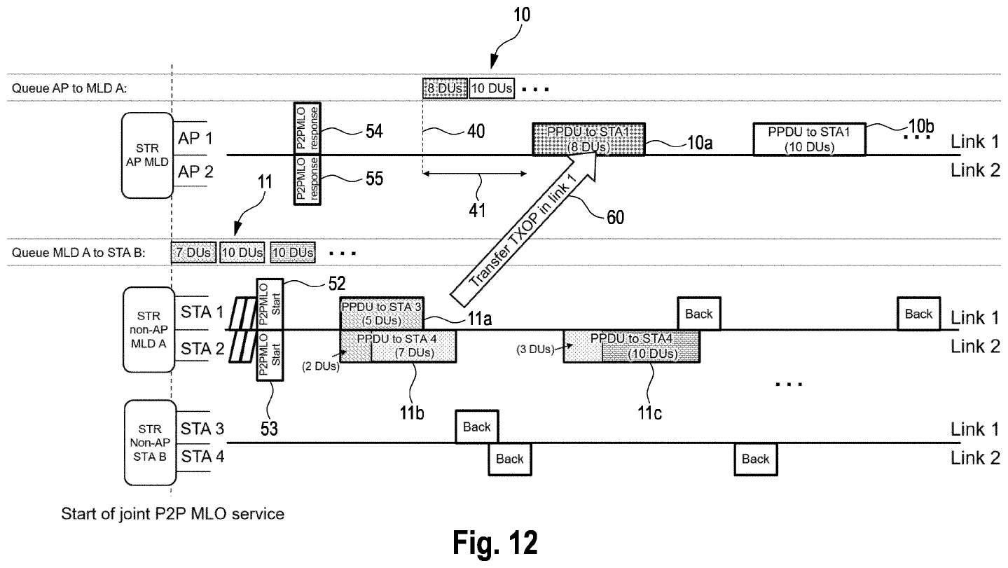

Next, embodiments will be described similar to FIG. 11, but where the MLD A starts channel access. A simple solution (not separately illustrated in FIG. 12) is for the MLD A to wait to be triggered since the AP should know the expected P2P traffic arrival time.

Alternatively, if traffic is queued unexpectedly earlier, the MLD A can obtain a TXOP on each link and hand the TXOPs over to the AP and wait to be triggered. The TXOP handover mechanisms will be explained in more detail below. A joint P2P MLO session start frame can be defined which can be used by the MLD A to share some additional information about the resources needed, e.g. depending on current channel conditions such as information that cannot be known beforehand, e.g., modulation and coding scheme (MCS), number of spatial streams (NSS), bandwidth, etc.

FIG. 12 shows an embodiment of a communication scheme according to the present disclosure that is similar to the communication scheme shown in FIG. 11, but where the MLD A starts channel access e.g. using enhanced distributed channel access (EDCA). The MLD A can obtain one TXOP in each link. The TXOP in link 1 may be used for infrastructure traffic, and the TXOP in link 2 may be used for P2P traffic. In link 1, the TXOP should be handed over to the AP at some point before the expected start of AP traffic 10 in link 1. In case the STA B is an MLD, then the MLD A can use both links to send data (shown as PPDUs 11a, 11b and 11c) to STA B. Then MLD A should handover (indicated by arrow 60) the TXOP in link 1 to the AP upon the expected AP traffic arrival 40, within a certain margin 41.

Since the P2P traffic 11 may face a hidden node issue, a “P2P MLO start” frame 52, 53 (also called “reservation indication”) may be sent by MLD A in both links, and the AP may then reply with a “P2P MLO response” 54, 55 (also called “reservation confirmation”) or it may repeat the “P2P MLO start” frame to provide medium reservation that would protect the P2P traffic 11 in link 2. Although the AP is responding to P2P MLD start, it is not participating in data exchange immediately but later, when the TXOP transfer 60 is initiated by STA 1. The “reservation indication” may also be useful to inform other STAs in the same basic service set (BSS) that the first link is occupied (i.e. to enable a network allocation vector (NAV) allocation).

Thus, in the embodiments shown in FIGS. 11 and 12 the two links are reserved by transmitting second data units to the third communication device once second data units are queued at the second communication device.

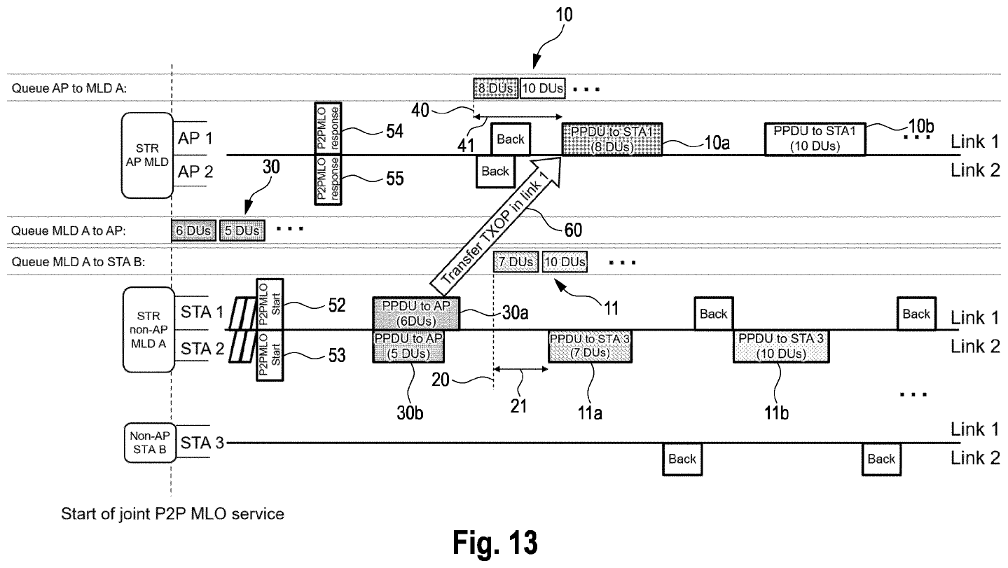

FIG. 13 shows another embodiment of a communication scheme according to the present disclosure that is similar to the communication scheme shown in FIG. 12, but where third DUs 30 are initially queued at the MLD A for transmission to the AP. After the transmission of the “P2P MLO start” frame 52, 53 by MLD A in both links and reply by the AP by transmitting the “P2P MLO response” 54, 55, the third DUs (in the PPDUs 30a and 30b) are transmitted to the AP. Afterwards, at the expected arrival time 40 of the first DUs 10, the MLD A hands over the link 1 to the AP and, within a margin 21 after the arrival time 20 of second DUs 11, transmits the second DUs 11 (in the PPDUs 11a and 11b) to the STA B.

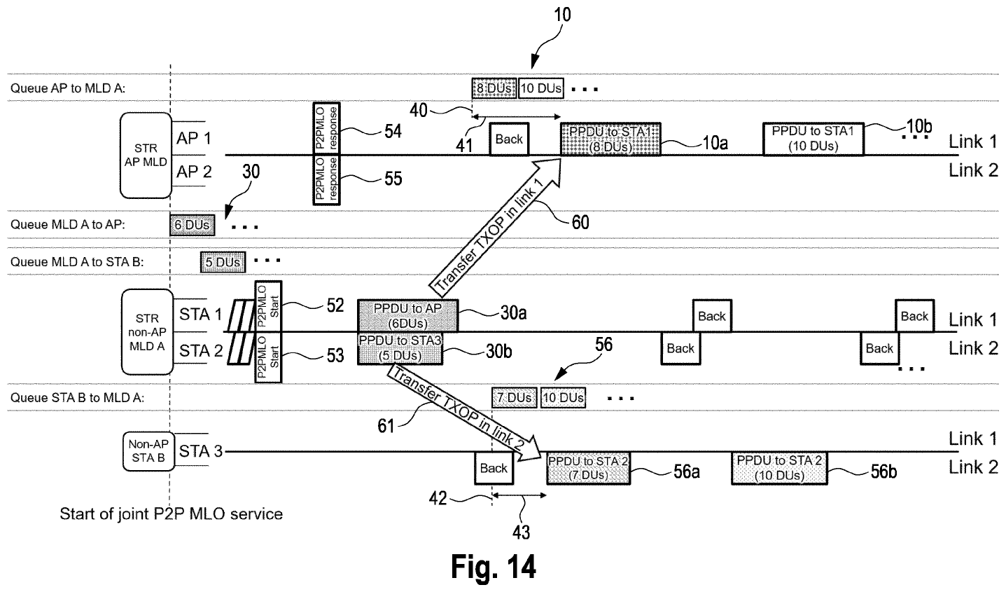

FIG. 14 shows another embodiment of a communication scheme according to the present disclosure that is similar to the communication scheme shown in FIG. 12, but where third DUs 30 are initially queued at the MLD A for transmission to the AP and the STA B. After the transmission of the “P2P MLO start” frame 52, 53 by MLD A in both links and reply by the AP by transmitting the “P2P MLO response” 54, 55, the third DUs 30 are transmitted to the AP (PPDU 30a on link 1) and the STA B (PPDU 30b on link 2), respectively.

Afterwards, at the expected arrival time 40 of DUs 10, the MLD A hands over (arrow 60) the link 1 to the AP and, at the expected arrival time 42 of DUs 56, the MLD A hands over (arrow 61) the link 2 to the STA B. The AP then transmits the first DUs 10 (in PPDUs 10a and 10b) on link 1 to the STA 1 of MLD A, and the STA B then transmits, within a margin 43, the DUs 56 (in PPDUs 56a and 56b) on link 2 to the STA 2 of MLD A.

Thus, in the embodiments shown in FIGS. 13 and 14 the two links are reserved by transmitting third data units to the first communication device (and optionally the third communication device) once third data units are queued at the second communication device.

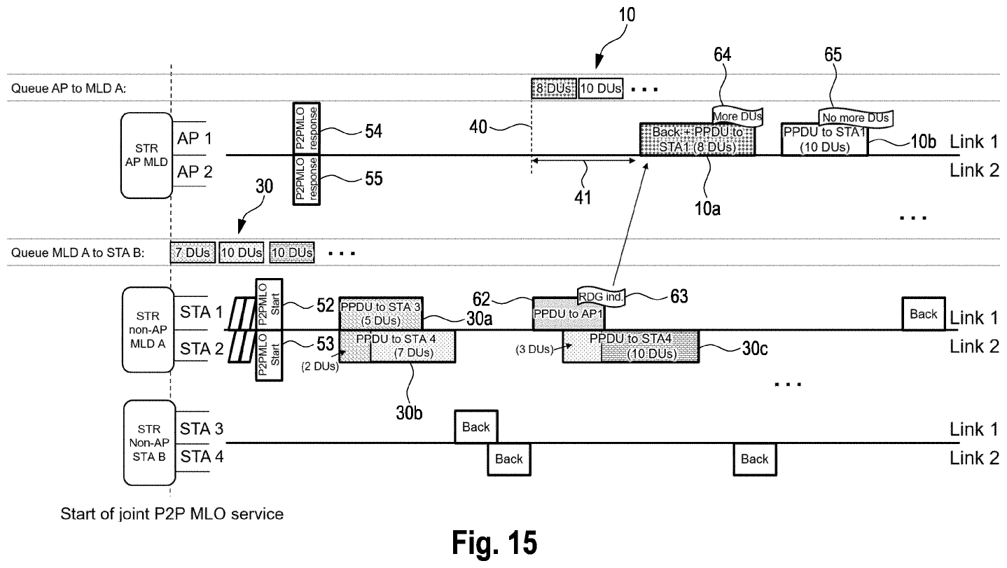

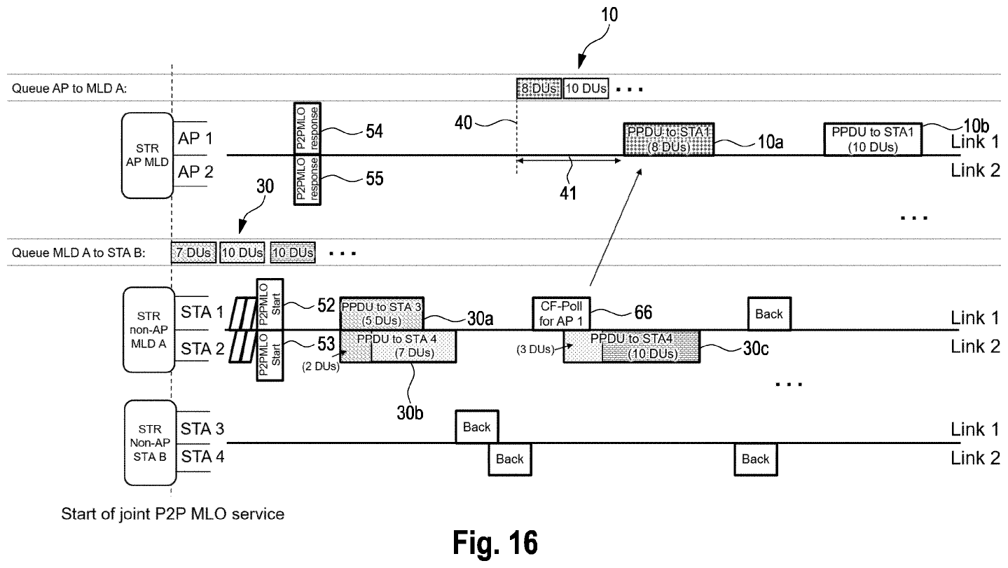

FIGS. 15 and 16 show embodiments of a communication scheme according to the present disclosure using different options for TXOP handover, which may be applied in the communication schemes shown in FIGS. 12 to 14. Both options use the transmission of a transmission grant by the MLD A to the other device to which the TXOP (for one or both links) shall be handed over. According to FIG. 15 reverse direction grant (RDG) is used as transmission grant and according to FIG. 16 a contention free Poll (CF-Poll) message is used as transmission grant.

In the case of using RDG (FIG. 15), the STA 1 sends a PPDU 62 (which may carry data for the AP 1) to the AP 1 that contains an RDG indication 63 that allows the AP 1 to send DUs to the STA 1, e.g. in bursts. Alternatively, a separate RDG information may be sent by the STA 1 to the AP. In each PPDU 10a, 10b the AP 1 may include a continuation indication 64 (“More DUs”) or 65 (“No more DUs”) to indicate if it wants to send more DUs in another PPDU or if it has finished its transmission and the STA 1 can regain the TXOP ownership. To send several PPDUs one after the other, the AP 1 may support a delayed acknowledgment for these PPDUs. The acknowledgement would be sent by STA 1 once the RDG has ended.

In the case of using CF-Poll (FIG. 16), the STA 1 as the TXOP holder, sends the CF-Poll frame/message 66 addressed to AP 1 separately to allocate a TXOP to the AP1 within a specific time limit.

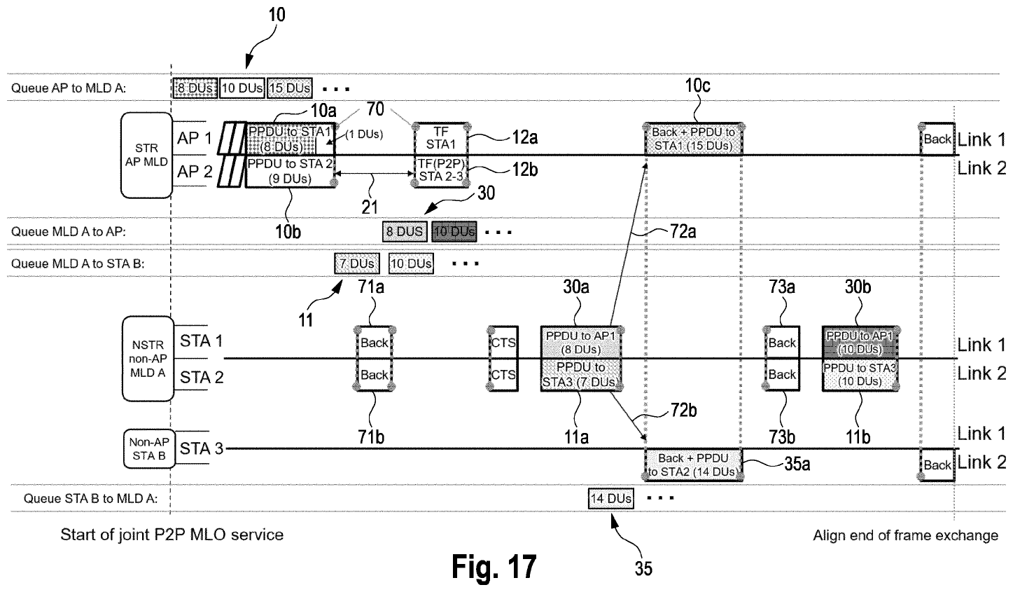

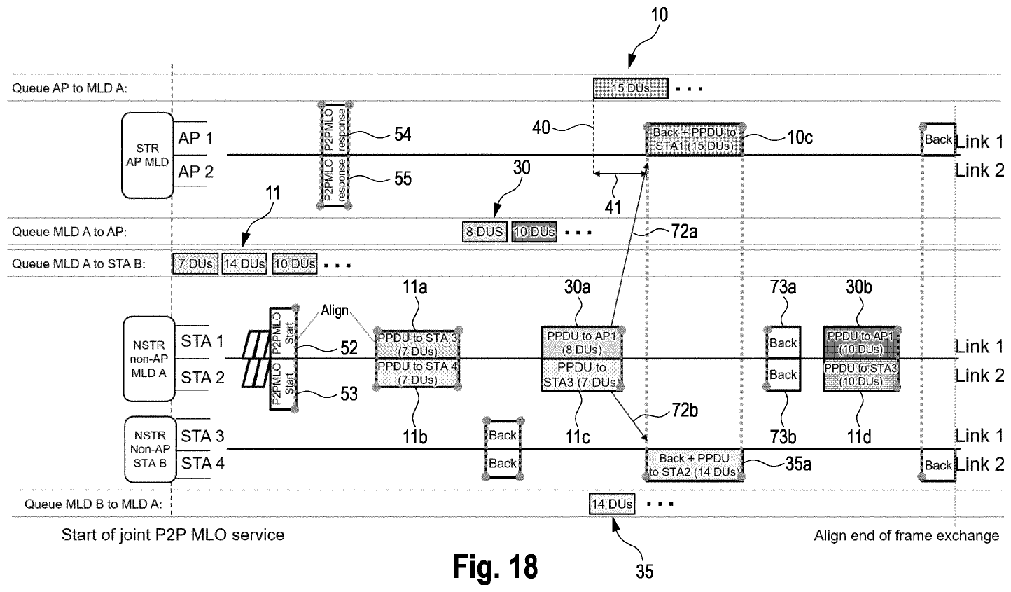

In the above, embodiments of the present disclosure have been explained with reference to FIGS. 4 to 16 where the non-AP MLD A is STR. In the following, embodiments of the present disclosure will be explained with reference to FIGS. 17 and 18 where the non-AP MLD A is non-STR (NSTR), i.e., it cannot simultaneously transmit and receive data/frames in different links. Thus, to use several links, the NSTR MLD transmits or receives in all links at the same time. The transmissions to or from the NSTR MLD in all links should therefore be aligned in time. In the following it is assumed that the channel access mechanism supports a joint P2P MLO session when the MLD A only supports NSTR operation FIG. 17 shows an embodiment of a communication scheme according to the present disclosure in which the AP traffic 10 (including the first DUs), from AP to non-AP MLD A, is queued first. The general operation is similar to the operation illustrated in FIG. 4. Olf the AP has enough traffic to fill both links, it obtains a TXOP in link 1 and another TXOP in link 2. The key difference in this case is that the transmissions to MLD A and expected responses are aligned in time as shown by the dotted lines with circular endings (e.g. lines 70).

The initial PPDUs 10a, 10b from AP 1 to STA 1 and from AP 2 to STA 2, respectively, have an aligned beginning and end. In addition, the response acknowledgement (Back) 71a, 71b is aligned in time as well. To transfer the TXOP to MLD A for P2P traffic 11, the AP sends two triggers or trigger frames TFs 12a, 12b, one in each link, to share the TXOP with STA 1 and STA 2. This gives the NSTR MLD A control over the start of transmissions to allow their time alignment.

The PPDUs 11a, 30a and 11b, 30b transmitted by MLD A are aligned. Optionally, RDG is enabled in link 1 to allow traffic (PPDU 10c) from the AP to MLD A. At the same time, because of the NSTR operation, RDG may also enabled in link 2, allowing the STA 3 to send data 35 (PPDU 35A) to MLD A. In addition, the start time and the time duration of the reverse direction PPDU 10c from AP 1 and the reverse direction PPDU 35a from STA 3 are aligned. This alignment information 72a, 72b may be signaled by the MLD A in the preceding frames. The start time may be implicitly taken by counting a fixed interframe space (IFS) time after the previous PPDUs since these had an aligned ending.

A variant of the single response scheduling (SRS) field can be used to indicate the duration that the response PPDUs 10c, 35a from AP 1 and STA 3 should have. If the actual response it too short, padding may be used.

Since the MLD A is aware of the traffic that needs to be sent by AP 1 and STA B (from the joint P2P MLO set up), it can estimate a response PPDU duration based on one or more of:
minimum amount of data needed to be sent by the AP and STA B to satisfy latency requirements;
maximum amount of expected queued data at the AP and STA B to minimize the need for padding;
channel conditions PHY configuration parameters that affect the PPDU duration, e.g., MCS, NSS, bandwidth.

The SRS field is defined for a single response. Depending on the amount of queued traffic at the AP and STA B, this field may be modified to allow a burst of several PPDUs in each link that end at the same time. After receiving the last PPDU in the RDG, the MLD A sends aligned acknowledgements 73a, 73b and continues sending aligned frames (PPDUs 11b, 30b) to the AP and STA B until the TXOP ends.

FIG. 18 shows an embodiment of a communication scheme according to the present disclosure in which the P2P traffic 11 (including the second DUs), from the MLD A to STA B, is queued first. In this case, the MLD A obtains a TXOP in link 1 and another TXOP in link 2, where P2P MLO start frames 52, 53 and response frames 54, 55 can be changed between the MLD A and the AP at the start for wireless medium reservation and to share further information in channel conditions and/or PHY configuration.

In case STA B is also an MLD, the MLD A starts sending frames to STA B in both links with aligned PPDUs 11a, 11b to support NSTR operation. If the STA B is not an MLD, the MLD A sends data (PPDUs 11c, 11d) to the STA B over link 2 and occupies link 1 with data towards the AP (PPDUs 30a, 30b) or another STA as long as the PPDUs are aligned in both links. In case there is not enough data to occupy both links until the expected arrival of AP traffic 10, the MLD A may only obtain one TXOP in link 2. Once there is queued traffic to occupy both links and two TXOPs have been established, MLD A continues operation as explained with respect to FIG. 17.

It should be noted that herein the terms “transmit” (or “send”) and “receive” shall not be understood such that reception is excluded in case of transmission and that transmission is excluded in case of reception. Rather, a transmission may also include a reception and a reception may also include a transmission like in case of an exchange of data or frames. For instance, when a communication unit transmits data, it may receive feedback from the recipient, e.g. in the form of an acknowledgement Ack or Back.

There are different options disclosed herein how one or more links can be reserved. Generally, the reservation of links for data traffic may be done by performing channel access on all links and exchanging frames, e.g. from another data traffic, until the first data traffic is queued for transmission.

In summary, the present disclosure presents communication devices and methods for use in a joint P2P MLO session where P2P communication and MLO are utilized jointly to support low latency traffic that needs to be exchanged by multiple communication devices. Further, mechanisms for coordinated channel access that can reduce the latency and increase the reliability of communications are disclosed. These mechanisms can advantageously be used in applications where the QoS of the traffic exchanged by multiple devices within the session is correlated and/or dependent on each other.

Thus, the foregoing discussion discloses and describes merely exemplary embodiments of the present disclosure. As will be understood by those skilled in the art, the present disclosure may be embodied in other specific forms without departing from the spirit or essential characteristics thereof. Accordingly, the disclosure of the present disclosure is intended to be illustrative, but not limiting of the scope of the disclosure, as well as other claims. The disclosure, including any readily discernible variants of the teachings herein, defines, in part, the scope of the foregoing claim terminology such that no inventive subject matter is dedicated to the public.

In the claims, the word “comprising” does not exclude other elements or steps, and the indefinite article “a” or “an” does not exclude a plurality. A single element or other unit may fulfill the functions of several items recited in the claims. The mere fact that certain measures are recited in mutually different dependent claims does not indicate that a combination of these measures cannot be used to advantage.

In so far as embodiments of the disclosure have been described as being implemented, at least in part, by software-controlled data processing apparatus, it will be appreciated that a non-transitory machine-readable medium carrying such software, such as an optical disk, a magnetic disk, semiconductor memory or the like, is also considered to represent an embodiment of the present disclosure. Further, such a software may also be distributed in other forms, such as via the Internet or other wired or wireless telecommunication systems.

The elements of the disclosed devices, apparatus and systems may be implemented by corresponding hardware and/or software elements, for instance appropriate circuits or circuitry. A circuit is a structural assemblage of electronic components including conventional circuit elements, integrated circuits including application specific integrated circuits, standard integrated circuits, application specific standard products, and field programmable gate arrays. Further, a circuit includes central processing units, graphics processing units, and microprocessors which are programmed or configured according to software code. A circuit does not include pure software, although a circuit includes the above-described hardware executing software. A circuit or circuitry may be implemented by a single device or unit or multiple devices or units, or chipset(s), or processor(s).

It follows a list of further embodiments of the disclosed subject matter:

1. First communication device configured to simultaneously exchange data units via at least two links with one or more other communication devices including a second communication device that is configured to simultaneously exchange data units via at least two links with at least one or more third communication devices, the first communication device comprising circuitry configured to reserve, if second data units are expected to be queued at the second communication device at an expected arrival time, two links for data exchange once first data units are queued at the first communication device or once third data units are queued at the second or third communication device.

2. First communication device as defined in embodiment 1, wherein the circuitry is configured to:
use at least a first link of the two reserved links for transmitting the first data units once the first data units are queued at the first communication device; and
hand over the second link of the two reserved links at or after the expected arrival time allowing the second communication device to transmit the second data units via the second link.

3. First communication device as defined in any one of the preceding embodiments, wherein the circuitry is configured to reserve the two links by one or more of the following:
transmitting first data units to the second communication device once first data units are queued at first communication device;
triggering the second communication device to transmit third data units to the first and/or third communication device once third data units are queued at the second communication device; and
triggering the third communication device to transmit third data units to the first and/or second communication device once third data units are queued at the third communication device.

4. First communication device as defined in any one of the preceding embodiments, 24 wherein the circuitry is configured to hand over the second link by transmitting a trigger or trigger frame to the second communication device.

5. First communication device as defined in embodiment 2, wherein the circuitry is configured to receive, in response to the trigger or trigger frame, a handover response from the second communication device, if any, indicating the status of the second data units at the second communication device.

6. First communication device as defined in any one of the preceding embodiments, wherein the circuitry is configured to determine the expected arrival time based on traffic information received from the second communication device, the traffic information comprising one or more of requirements, characteristics and content information of the second data units that are expected to be queued.

7. First communication device as defined in any one of the preceding embodiments, wherein the circuitry is configured, in case first data units have been queued at the first communication device for transmission to the second communication device before the expected arrival time of the second data units at the second communication device, to use the second link, before it is handed over to the second communication device, for transmitting part of the first data units to the second communication device.

8. First communication device as defined in embodiment 7, wherein the circuitry is configured to include in the part of the first data units one or more first data units and/or one or more repetitions of first data units.

9. First communication device as defined in embodiment 7 or 8, wherein the circuitry is configured to stop using the second link for transmitting part of the first data units to the second communication device at or a time period after the expected arrival time or an updated arrival time of the second data units at the second communication device.

10. First communication device as defined in embodiment 7, 8 or 9, wherein the circuitry is configured, in case no second data units have been queued at the second communication device for transmission to the third communication device at or a predetermined time period after the expected arrival time, to continue using the second link for transmitting part of the first data units to the second communication device or to stop using the second link.

11. First communication device as defined in any one of the preceding embodiments, wherein the circuitry is configured to align the beginning and/or end of the transmissions of respective parts of the first data units on the first and second links to the second communication device.

12. First communication device as defined in any one of the preceding embodiments, wherein the circuitry is configured, at or after the expected arrival time, to hand over the first link and the second link to the second communication device allowing the second communication device to simultaneously transmit data units to the first communication device via the first link and transmit the second data units to the third communication device via the second link.

13 First communication device as defined in any one of the preceding embodiments, wherein the circuitry is configured, after receipt of a transmission grant and/or a transmission timing information from the second communication device, to transmit first data units to the second communication device.

14. First communication device as defined in embodiment 13, wherein the circuitry is configured to align, based on the transmission timing information, the beginning and/or end of the transmission of the first data units on the first link to the second communication device with the transmission of data units on the second link from the third communication device to the second communication device.

15. First communication device as defined in any one of the preceding embodiments, wherein the circuitry is configured, in case at the expected arrival time of the second data units at the second communication device no first data units have been queued at the first communication device for transmission to the second communication device, to
use the first link for data exchange with another communication device or for broadcasting of data units;
at the same time, hand over the second link to the second communication device; and
once the first data units are queued at the first communication device, stop using the first link for data exchange with another communication device or for broadcasting of data units and start using the first link for transmitting the first data units to the second communication device.

16. Second communication device configured to simultaneously exchange data units with a first communication device via at least a first link and with a third communication device via at least a second link, the second communication device comprising circuitry configured to:
receive a handover of the second link, reserved by the first communication device, from the first communication device at or after an expected arrival time at which second data units are expected to be queued at the second communication device, allowing the second communication device to transmit the second data units via the second link; and
transmit the second data units via the second link.

17. Second communication device as defined in embodiment 16, wherein the circuitry is configured to transmit, after being triggered by the first communication device, third data units to the first and/or third communication device once third data units are queued at the second communication device.

18. Second communication device as defined in any one of the embodiments 16 to 17, wherein the circuitry is configured to receive third data units transmitted by the third communication device, after being triggered by the first communication device, once third data units are queued at the third communication device.

19. Second communication device as defined in any one of the embodiments 16 to 18, wherein the circuitry is configured to receive first data units from the first communication device via at least the first link before the handover of the second link.

20. Second communication device as defined in any one of the embodiments 16 to 19, wherein the circuitry is configured to transmit a handover response to the first communication device after the second link has been handed over, said handover response indicating the status of the second data units comprising one or more of:
that second data units have been queued at the second communication device for transmission to the third communication device,
that no second data units have been queued at the second communication device for transmission to the third communication device,
that second data units will be queued later than the expected arrival time, and
an updated expected arrival time.

21. Second communication device as defined in any one of the embodiments 16 to 20, wherein the second communication device is configured to simultaneously transmit data units on the first and second links or to simultaneously receive data units on the first and second links but not to simultaneously transmit data units on one of the two links and receive data units on the other of the two links.

22. Second communication device as defined in embodiment 21, wherein the circuitry is configured to
receive a handover of the first link before or simultaneously with the handover of the second link from the first communication device to the second communication device, and,
after the handover of the first link and the second link from the first communication device to the second communication device, simultaneously transmit data units to the first communication device via the first link and transmit the second data units to the third communication device via the second link.

23. Second communication device as defined in embodiment 21 or 22, wherein the circuitry is configured to align the beginning and/or end of the transmissions of data units on the first link to the first communication device and on the second link to the third communication device.

24. Second communication device as defined in any one of embodiments 21, 22 or 23, 28 wherein the circuitry is configured to transmit a transmission grant to the first and third communication devices allowing the first and third communication device to transmit data units to the second communication device.

25. Second communication device as defined in embodiment 24, wherein the circuitry is configured to transmit the transmission grant in the form of a reverse direction grant, RDG, included in a data unit or by transmitting a separate contention free (CF) poll message to the first and third communication devices.

26. Second communication device as defined in any one of embodiments 21 to 25, wherein the circuitry is configured to transmit a transmission timing information to the first and third communication devices indicating the start time, and/or stop time, and/or time duration of the transmissions of data units by the first and third communication devices to the second communication device.

27. First communication method of a first communication device configured to simultaneously exchange data units via at least two links with one or more other communication devices including a second communication device that is configured to simultaneously exchange data units via at least two links with at least one or more third communication devices, the first communication method comprising reserving, if second data units are expected to be queued at the second communication device at an expected arrival time, two links for data exchange once first data units are queued at the first communication device or once third data units are queued at the second or third communication device.

28. Second communication method of a second communication device configured to simultaneously exchange data units with a first communication device via at least a first link and with a third communication device via at least a second link, the second communication method comprising:
receiving a handover of the second link, reserved by the first communication device, from the first communication device at or after an expected arrival time at which second data units are expected to be queued at the second communication device, allowing the second communication device to transmit the second data units via the second link; and
transmitting the second data units via the second link.

29. A non-transitory computer-readable recording medium that stores therein a computer program product, which, when executed by a processor, causes the method according to embodiment 27 or 28 to be performed.

30. A computer program comprising program code means for causing a computer to perform the steps of said method according to embodiment 27 or 28 when said computer program is carried out on a computer.

A1. First communication device configured to simultaneously exchange data units via at least two links with one or more other communication devices including a second communication device that is configured to simultaneously exchange data units via at least two links with one or more other communication devices, the first communication device comprising circuitry configured to:
receive a handover of the first link, reserved by the second communication device, from the second communication device at or after an expected arrival time at which first data units are expected to be queued at the first communication device, allowing the first communication device to transmit the first data units via the first link; and
transmit the first data units via the first link.

A2 First communication device as defined in embodiment A1, wherein the circuitry is configured to transmit first data units to the second communication device once the first data units are queued at the first communication device.

A3. First communication device as defined in any one of the preceding embodiments, wherein the circuitry is configured to transmit, in response to receiving a reservation indication from the second communication device indicating that the second communication device is going to reserve the at least two links, a reservation confirmation indicating that the at least two links are reserved or a repetition of the reservation indication.

A4. First communication device as defined in any one of the preceding embodiments, wherein the circuitry is configured to receive the handover of the first link by receiving a transmission grant from the second communication device and to indicate in subsequently transmitted one or more of the first data units if further data units shall be transmitted and/or if transmission of the first data units is finished.

A5. First communication device as defined in any one of the preceding embodiments, wherein the circuitry is configured to receive the handover of the first link by receiving a poll message from the second communication device and subsequently to transmit first data units within a time limit indicated by the poll message.

A6. Second communication device configured to simultaneously exchange data units with a first communication device via at least a first link and with a third communication device via at least a second link, the second communication device comprising circuitry configured to:
reserve, if first data units are expected to be queued at the first communication device at an expected arrival time, once second or third data units are queued at the second communication device, two links for data exchange;

use at least a second link of the two reserved links for transmitting the second data units and/or receiving data units from the third communication device; and
hand over the first link of the two reserved links at or after an expected arrival time at which first data units are expected to be queued at the first communication device allowing the first communication device to transmit the first data units via the first link.

A7. Second communication device as defined in embodiment A6, wherein the circuitry is configured to reserve the two links by performing one or more of:
transmitting second data units to the third communication device once second data units are queued at second communication device, and
transmitting third data units to the first communication device once third data units are queued at the second communication device.

A8. Second communication device as defined in any one of embodiments A6 to A7, wherein the circuitry is configured to transmit, before reserving the two links, a reservation indication to the first communication device indicating that the second communication device is going to reserve the two links.

A9. Second communication device as defined in any one of embodiments A6 to A8, wherein the circuitry is configured to hand over the first link by transmitting a transmission grant or a poll message to the first communication device.

A10. Second communication device as defined in embodiment A9, wherein the circuitry is configured to transmit the transmission grant in the form of a reverse direction grant, RDG, included in a data unit or by transmitting a separate contention free, CF, poll message to the first communication device.

A11. Second communication device as defined in any one of embodiments A6 to A 10, wherein the circuitry is configured to determine the expected arrival time based on traffic information received from the first communication device, the traffic information comprising one or more of requirements, characteristics and content information of the first data units that are expected to be queued.

A12. Second communication device as defined in any one of embodiments A6 to A11, wherein the circuitry is configured to use the first link, before it is handed over to the first communication device, for transmitting part of the second data units to the third communication device and/or for transmitting first data units to the first communication device.

A13. Second communication device as defined in embodiment A12, wherein the circuitry is configured to include in the part of the second data units one or more second data units and/or one or more repetitions of second data units.

A14. Second communication device as defined in embodiment A12 or A13, wherein the circuitry is configured to stop using the first link for transmitting part of the second data units to the third communication device at or a time period after the expected arrival time or an updated arrival time of the first data units at the first communication device.

A15. Second communication device as defined in embodiment A12, A13 or A14, wherein the circuitry is configured, in case no first data units have been queued at the first communication device for transmission to the second communication device at the expected arrival time, to continue using the first link for transmitting part of the second data units to the third communication device or to stop using the first link.

A16. Second communication device as defined in any one of embodiments A6 to A 15, wherein the second communication device is configured to simultaneously transmit data units on the first and second links or to simultaneously receive data units on the first and second links but not to simultaneously transmit data units on one of the two links and receive data units on the other of the two links.

A17. Second communication device as defined in embodiment A16, wherein the circuitry is configured to, after handing over the first link to the first communication device, transmit timing information to the first and third communication devices indicating the start time, and/or stop time, and/or time duration of the transmissions of data units by the first and third communication devices to the second communication device.

A18. Second communication device as defined in embodiment A16 or A17, wherein the circuitry is configured, before the handover of the first link to the first communication device, to simultaneously transmit data units to the first or third communication device via the first link and transmit the second data units to the third communication device via the second link.

A19. Second communication device as defined in any one of embodiment A16, A17 or A18,
wherein the circuitry is configured to align the beginning and/or end of the transmissions of respective parts of the second data units on the first and second links to the third communication device.

A20. Second communication device as defined in embodiment A8, wherein the circuitry is configured to align the beginning and/or end of the transmission of the reservation indication to the first communication device.

A21. First communication method of a first communication device configured to simultaneously exchange data units via at least two links with one or more other communication devices including a second communication device that is configured to simultaneously exchange data units via at least two links with one or more other communication devices, the first communication method comprising:
receiving a handover of the first link, reserved by the second communication device, from the second communication device at or after an expected arrival time at which first data units are expected to be queued at the first communication device, allowing the first communication device to transmit the first data units via the first link; and
transmitting the first data units via the first link.

A22. Second communication method of a second communication device configured to simultaneously exchange data units with a first communication device via at least a first link and with a third communication device via at least a second link, the second communication method comprising:
reserving, if first data units are expected to be queued at the first communication device at an expected arrival time, once second or third data units are queued at the second communication device, two links for data exchange;
using at least a second link of the two reserved links for transmitting the second data units and/or receiving data units from the third communication device; and
handing over the first link of the two reserved links at or after an expected arrival time at which first data units are expected to be queued at the first communication device allowing the first communication device to transmit the first data units via the first link.

A23. A non-transitory computer-readable recording medium that stores therein a computer program product, which, when executed by a processor, causes the method according to embodiment A21 or A22 to be performed.

A24. A computer program comprising program code means for causing a computer to perform the steps of said method according to embodiment A21 or A22 when said computer program is carried out on a computer.

1. First communication device configured to simultaneously exchange data units via at least two links with one or more other communication devices including a second communication device that is configured to simultaneously exchange data units via at least two links with at least one or more third communication devices, the first communication device comprising circuitry configured to reserve, if second data units are expected to be queued at the second communication device at an expected arrival time, two links for data exchange once first data units are queued at the first communication device or once third data units are queued at the second or third communication device.

2. First communication device as claimed in claim 1, wherein the circuitry is configured to:
use at least a first link of the two reserved links for transmitting the first data units once the first data units are queued at the first communication device; and
hand over the second link of the two reserved links at or after the expected arrival time allowing the second communication device to transmit the second data units via the second link.

3. First communication device as claimed in claim 1, wherein the circuitry is configured to reserve the two links by one or more of the following:
transmitting first data units to the second communication device once first data units are queued at first communication device;
triggering the second communication device to transmit third data units to the first and/or third communication device once third data units are queued at the second communication device; and
triggering the third communication device to transmit third data units to the first and/or second communication device once third data units are queued at the third communication device.

4. First communication device as claimed in claim 1, wherein the circuitry is configured to hand over the second link by transmitting a trigger or trigger frame to the second communication device.

5. First communication device as claimed in claim 4, wherein the circuitry is configured to receive, in response to the trigger or trigger frame, a handover response from the second communication device, if any, indicating the status of the second data units at the second communication device.

6. First communication device as claimed in claim 1, wherein the circuitry is configured to determine the expected arrival time based on traffic information received from the second communication device, the traffic information comprising one or more of requirements, characteristics and content information of the second data units that are expected to be queued.

7. First communication device as claimed in claim 1, wherein the circuitry is configured, in case first data units have been queued at the first communication device for transmission to the second communication device before the expected arrival time of the second data units at the second communication device, to use the second link, before it is handed over to the second communication device, for transmitting part of the first data units to the second communication device.

8. First communication device as claimed in claim 1, wherein the circuitry is configured to align the beginning and/or end of the transmissions of respective parts of the first data units on the first and second links to the second communication device.

9. First communication device as claimed in claim 1, wherein the circuitry is configured, at or after the expected arrival time, to hand over the first link and the second link to the second communication device allowing the second communication device to simultaneously transmit data units to the first communication device via the first link and transmit the second data units to the third communication device via the second link.

10. First communication device as claimed in claim 1, wherein the circuitry is configured, after receipt of a transmission grant and/or a transmission timing information from the second communication device, to transmit first data units to the second communication device.

11. First communication device as claimed in claim 1, wherein the circuitry is configured, in case at the expected arrival time of the second data units at the second communication device no first data units have been queued at the first communication device for transmission to the second communication device, to
use the first link for data exchange with another communication device or for broadcasting of data units;
at the same time, hand over the second link to the second communication device; and
once the first data units are queued at the first communication device, stop using the first link for data exchange with another communication device or for broadcasting of data units and start using the first link for transmitting the first data units to the second communication device.

12. Second communication device configured to simultaneously exchange data units with a first communication device via at least a first link and with a third communication device via at least a second link, the second communication device comprising circuitry configured to:
receive a handover of the second link, reserved by the first communication device, from the first communication device at or after an expected arrival time at which second data units are expected to be queued at the second communication device, allowing the second communication device to transmit the second data units via the second link; and
transmit the second data units via the second link.

13. Second communication device as claimed in claim 12, wherein the circuitry is configured to transmit, after being triggered by the first communication device, third data units to the first and/or third communication device once third data units are queued at the second communication device.

14. Second communication device as claimed in claim 12, wherein the circuitry is configured to receive third data units transmitted by the third communication device, after being triggered by the first communication device, once third data units are queued at the third communication device.

15. Second communication device as claimed in claim 12, wherein the circuitry is configured to receive first data units from the first communication device via at least the first link before the handover of the second link.

16. Second communication device as claimed in claim 12, wherein the circuitry is configured to transmit a handover response to the first communication device after the second link has been handed over, said handover response indicating the status of the second data units comprising one or more of:
that second data units have been queued at the second communication device for transmission to the third communication device, that no second data units have been queued at the second communication device for transmission to the third communication device,
that second data units will be queued later than the expected arrival time, and
an updated expected arrival time.

17. Second communication device as claimed in claim 12, wherein the second communication device is configured to simultaneously transmit data units on the first and second links or to simultaneously receive data units on the first and second links but not to simultaneously transmit data units on one of the two links and receive data units on the other of the two links.

18. Second communication device as claimed in claim 17, wherein the circuitry is configured to align the beginning and/or end of the transmissions of data units on the first link to the first communication device and on the second link to the third communication device.

19. Second communication device as claimed in claim 17, wherein the circuitry is configured to transmit a transmission grant to the first and third communication devices allowing the first and third communication device to transmit data units to the second communication device.

20. Second communication device as claimed in claim 19, wherein the circuitry is configured to transmit the transmission grant in the form of a reverse direction grant, RDG, included in a data unit or by transmitting a separate contention free (CF) poll message to the first and third communication devices.

21. Second communication device as claimed in claim 17, wherein the circuitry is configured to transmit a transmission timing information to the first and third communication devices indicating the start time, and/or stop time, and/or time duration of the transmissions of data units by the first and third communication devices to the second communication device.

22. First communication method of a first communication device configured to simultaneously exchange data units via at least two links with one or more other communication devices including a second communication device that is configured to simultaneously exchange data units via at least two links with at least one or more third communication devices, the first communication method comprising reserving, if second data units are expected to be queued at the second communication device at an expected arrival time, two links for data exchange once first data units are queued at the first communication device or once third data units are queued at the second or third communication device.

23. Second communication method of a second communication device configured to simultaneously exchange data units with a first communication device via at least a first link and with a third communication device via at least a second link, the second communication method comprising:
receiving a handover of the second link, reserved by the first communication device, from the first communication device at or after an expected arrival time at which second data units are expected to be queued at the second communication device, allowing the second communication device to transmit the second data units via the second link; and
transmitting the second data units via the second link.

24-42. (canceled)

43. A non-transitory computer-readable recording medium that stores therein a computer program product, which, when executed by a processor, causes the method according to claim 22 to be performed.
